(19) United States
(12) Patent Application Publication
(10) Pub. No.: US 2017/0002715 A1
(43) Pub. Date: Jan. 5, 2017

(54) ICE-MELTING BI-DIRECTIONAL EXHAUST DIVERTER WITH SELECTABLE FLOW CONTROL

(71) Applicant: Bobby Snow, Scranton, AR (US)

(72) Inventor: Bobby Snow, Scranton, AR (US)

(21) Appl. No.: 14/791,464

(22) Filed: Jul. 5, 2015

(51) Int. Cl. F01N 13/08; F16K 11/04

(52) U.S. Cl. CPC F01N 13/082; F16K 11/04

(57) ABSTRACT

An ice-melting exhaust diverter with selectable flow control is disclosed. The ice-melting exhaust diverter includes an exhaust inflow opening configured to receive exhaust from an internal combustion engine, a first exhaust outflow opening configured to release exhaust rearward, a second exhaust outflow opening configured to release exhaust downward, and a diverter plate having a selectable control to direct exhaust flow rearward or downward through either the first outflow opening or the second outflow opening, respectively.

### FIELD OF THE INVENTION

The present invention relates broadly to automotive exhaust systems, and more particularly to exhaust tail pipes.

### BACKGROUND OF THE INVENTION

Anyone who lives in a freezing climate and drives a car has encountered loss of traction, spinning tires on icy surfaces, sometimes striking another car, and thereby causing damage. Sheets of ice form over roads and in parking lots, and wherever one wishes to drive a car or truck, the hazards and inconveniences of icy conditions contribute to numerous accidents and injuries.

Often, motorists will find themselves unable to move because of ice or icy surfaces. Numerous examples exist of prior solutions aimed at directing heat from a motor of a car or truck to the wheels of that same vehicle, in an effort to direct heat toward wheels and the ground near the wheels where the wheels have little or no traction. However, none of these solutions have ever gained widespread acceptance or use among motorists, because the equipment that is required is bulky, and is also difficult for the average motorist to carry and manage.

### SUMMARY OF THE INVENTION

A general aspect of the invention is an ice-melting exhaust diverter with selectable flow control. The exhaust diverter includes: an inflow exhaust conduit configured to receive exhaust from a combustion engine; a first outflow exhaust conduit configured to release exhaust rearward; a second outflow exhaust conduit configured to release exhaust downward; and a selectable flow controller configured to selectably direct exhaust from the inflow exhaust conduit either rearward through the first outflow exhaust conduit, or downward through the second outflow exhaust conduit.

In some embodiments, the selectable flow controller includes a diverter plate and a selectable control, the diverter plate being movable by the selectable control so as to obstruct one of the first outflow exhaust conduit, or the second outflow exhaust conduit. In further embodiments, the selectable control includes a rotating arm connected to the diverter plate. In further embodiments, the selectable control includes a selector arm connected to the rotating arm. In further embodiments, the selector arm is connected to a control cable that runs from the selectable flow controller to an operational location. In further embodiments, the operational location is inside an automobile trunk.

In some embodiments, the inflow exhaust conduit attaches directly to a muffler connected to a combustion engine exhaust system.

In some embodiments, an opening of the second outflow exhaust conduit configured to release exhaust downward is substantially parallel to the ground.

In some embodiments, an opening of the second outflow exhaust conduit configured to release exhaust downward s configured to be at an angle of approximately 45 degrees to the ground.

Another general aspect of the invention is an ice-melting automotive exhaust apparatus which includes: a remote-located selector; and a bi-directional exhaust flow diverter having an exhaust inflow opening, an exhaust outflow rearward opening, an exhaust outflow downward opening, and an exhaust flow diverter plate configured to direct exhaust flow from the exhaust inflow opening, to either the exhaust outflow rearward opening or the exhaust outflow downward opening, wherein the remote-located selector is operatively connected to the exhaust flow diverter plate, and positions the exhaust flow diverter plate so as to obstruct one of the exhaust outflow rearward opening and the exhaust outflow downward opening.

In some embodiments, the remote-located selector includes a cable running from an automobile trunk to a selector arm controlling the exhaust flow diverter plate. In further embodiments, the selector arm is connected to a rotating arm, and the rotating arm is connected to the diverter plate.

In some embodiments, the remote-located selector is a tensioned cable connected to the selector arm.

In some embodiments, the selector arm is connected to the rotating arm at an angle of approximately 90 degrees.

In some embodiments, the exhaust outflow downward opening is configured at an angle of approximately 45 degrees with respect to the exhaust tail pipe.

In some embodiments, the exhaust outflow downward opening is substantially parallel to a road surface.

In some embodiments, the exhaust inflow opening attaches to a muffler on a vehicle having a combustion engine.

In some embodiments, the exhaust outflow downward opening is a lateral flow spreader configured to spread out the flow of hot exhaust gases over a road surface.

Another general aspect of the invention is a method of melting ice under a vehicle. The method includes; operating an internal combustion engine over an icy road surface; selecting a downward direction for exhaust flow on a bi-directional exhaust diverter connected to the internal combustion engine; and melting ice on the icy road surface using the exhaust flowing downward from the bidirectional exhaust diverter to the icy road surface.

In some embodiments, selecting a downward direction for exhaust flow includes operating a remotely-located control cable connected to a selector arm so as to obstruct an exhaust outflow rearward opening, thereby directing exhaust flow through an exhaust outflow downward opening.

### BRIEF DESCRIPTION OF THE DRAWINGS

Many additional features and advantages of the present invention will become apparent from reading the following detailed description, when considered in conjunction with the drawings.

FIG. 1 is a perspective view of a car having the ice-melting exhaust diverter of the invention capable of directing exhaust in either a rearward direction or a downward direction so as to melt ice under the car.

FIG. 2 is a close-up underside perspective view of the ice-melting exhaust diverter of FIG. 1, with the ice-melting exhaust diverter directing exhaust in a rearward direction.

FIG. 3 is a side view of the ice-melting exhaust diverter with a diverter plate oriented to direct exhaust flow in a rearward direction.

FIG. 4 is a cut-away side view of the ice-melting exhaust diverter of FIG. 3 with the diverter plate oriented to direct exhaust flow in a rearward direction.

FIG. 5 is a side view of the ice-melting exhaust diverter with the diverter plate oriented to direct exhaust flow in a downward direction.

FIG. 6 is a cut-away side view of the ice-melting exhaust diverter shown in FIG. 5, with the diverter plate oriented to direct exhaust flow in a downward direction.

### DETAILED DESCRIPTION

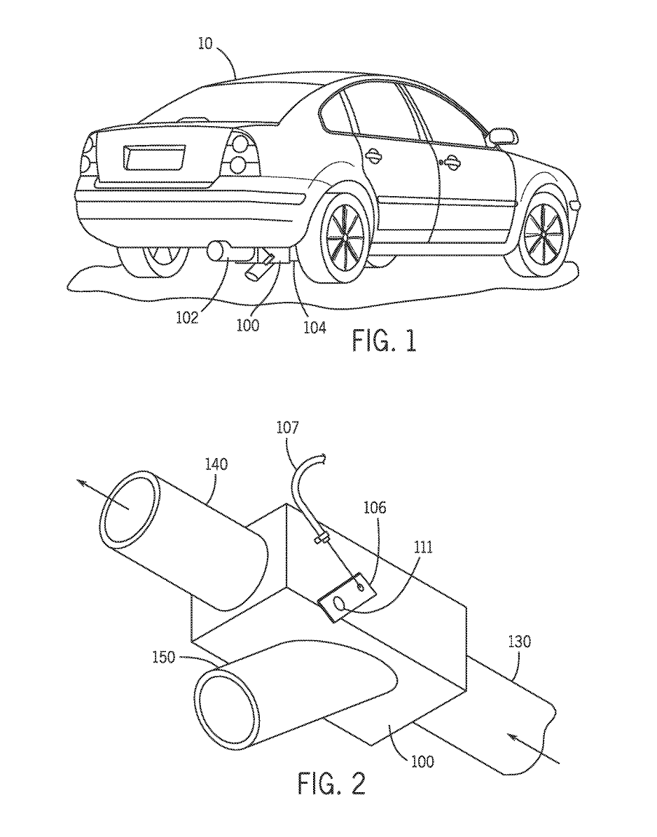

Directing attention now to the drawings, FIG. 1 shows vehicle 10 having a bi-directional ice-melting exhaust diverter 100 near the rear of vehicle 10, and attached between tailpipe 102 and muffler (or resonator) 104. While illustrated as an automobile, it is to be understood that vehicle 10 can be any vehicle with two or more wheels that is powered by an internal combustion engine that produces a flow of hot exhaust gases. It is also to be understood that while exhaust diverter 100 is displayed at the rear of vehicle 10, exhaust diverter 100 can be installed elsewhere under vehicle 10 along the exhaust system.

Exhaust diverter 100 is a bi-directional exhaust flow director that directs exhaust emissions from a combustion engine that powers vehicle 10. When exhaust diverter 100 is in normal mode, exhaust flow is not diverted downward, and passes through diverter 100 to tailpipe 102 to exit vehicle 10 in a normal rearward direction. By contrast, when the exhaust diverter 100 is used to melt ice on the road surface below the vehicle 10, exhaust flow is diverted away from the tailpipe 102, so it can be directed downward towards ice on the road, the heat carried by the exhaust flow melting the ice.

Directing attention to FIG. 2, the exhaust diverter 100 has an inflow conduit 130 which can be connected to the exhaust outflow of a muffler 104, for example. The exhaust diverter 100 also has a rearward outflow conduit 140 which can be connected to a tail pipe 102, and a downward outflow conduit 150. The downward outflow conduit 150 can be connected to a lateral flow spreader so as to spread out the flow of hot exhaust gases so that they sweep over a wider area than the width of the downward outflow conduit 150.

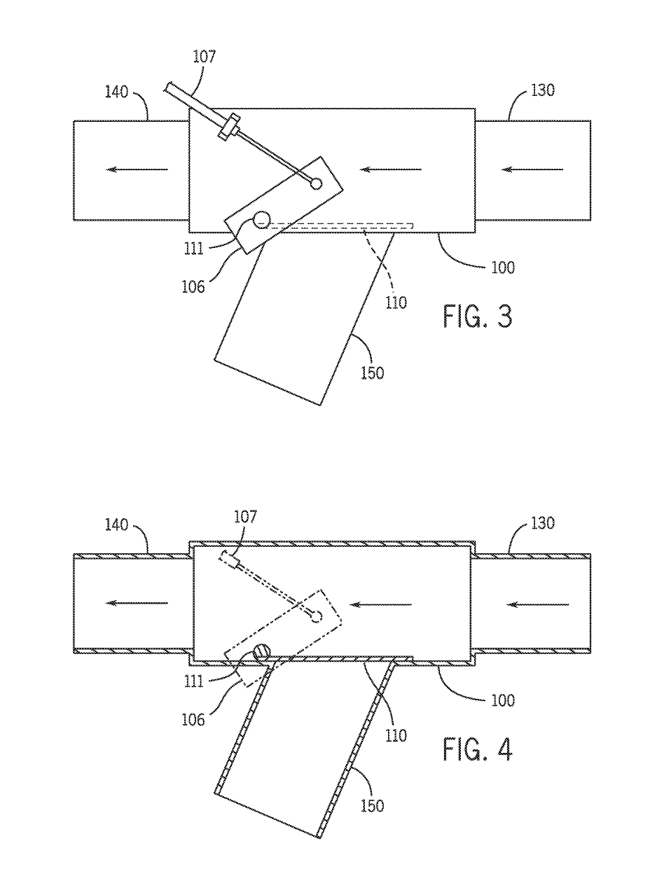

Again referring to FIG. 2, an embodiment of exhaust diverter 100 is shown with selector arm 106, which controls via control cable 107 the position of diverter plate 110 (see FIG. 3) located within exhaust diverter 100. In an embodiment, control cable 107 is a tensioned cable having an outer sleeve containing the cable, similar to accelerator cables and clutch cables used on automobiles. Control cable 107 is typically run from exhaust diverter 100 into a rear portion of vehicle 10, such as the trunk portion of an automobile where it is out of the way, and may assume two different locking positions within an angle span of about 45 degrees, one for diverter plate 110 in an open position and one for diverter plate 110 in a closed position. Other locations for mounting control cable 107 may include areas behind rearmost seats in an automobile, rear portions of truck beds, and the like. Control cable 107 may be placed in vehicle 10 in more forward locations, such as near a driver's seat, on a dashboard, or elsewhere, for remote operation.

In some embodiments, diverter plate 110 is affixed to rotating arm 111 in an angular relationship such that diverter plate 110 obstructs one of two exit paths for exhaust flow within exhaust diverter 100, namely exhaust flow rearward and exhaust flow downward. Rotating arm 111 is connected to selector arm 106, typically in an angular relationship.

As shown in FIGS. 3 and 4, selector arm 106 is in normal pass-through orientation and exhaust flows rearward through the body of exhaust diverter 100, entering exhaust diverter 100 at exhaust inflow opening 130 and flowing to exhaust outflow rearward opening 140.

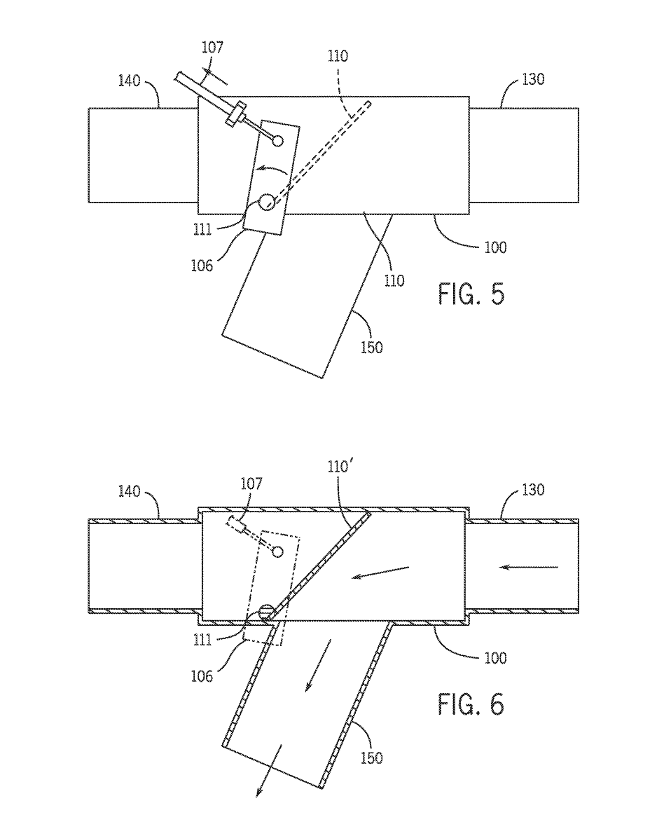

Directing attention to FIGS. 5 and 6, exhaust diverter 100 is shown with selector arm 106 in the upward position. In this embodiment, this orientation of selector arm 106 rotates diverter plate 110 into an upwardly inclined orientation that diverts exhaust flow from exhaust inflow opening 130 downward to exhaust outflow downward opening 150. Exhaust flow is thereby prevented from passing to tailpipe 102, instead being diverted downward toward the road surface under vehicle 10.

Directing attention to FIG. 6, a cut-away side view of the exhaust diverter 100 is displayed showing the path that exhaust gasses take, entering the inflow conduit 130, being deflected off the diverter plate 110′, and exiting downward through the outflow conduit 150.

The diverter plate 110 is held in place by tension on the cable of 107, which pulls on the selector arm 106, which pivots about rotating arm 111. As shown, diverter plate 110 is a simple flap-type valve that directs gas flow, and seats in one of two positions so as to effectively seal off one conduit against exhaust flow, and direct it towards and open the other conduit.

While an ice-melting exhaust diverter has been illustrated and described in detail in the embodiments described herein, various modifications can be made to these embodiments without departing from the spirit and scope as set forth in the following claims.

What is claimed is:

1. An ice-melting exhaust diverter with selectable flow control, the exhaust diverter comprising:
an inflow exhaust conduit configured to receive exhaust from a combustion engine;
a first outflow exhaust conduit configured to release exhaust rearward;
a second outflow exhaust conduit configured to release exhaust downward; and
a selectable flow controller configured to selectably direct exhaust from the inflow exhaust conduit either rearward through the first outflow exhaust conduit, or downward through the second outflow exhaust conduit.

2. The ice-melting exhaust diverter of claim 1, wherein the selectable flow controller includes a diverter plate and a selectable control, the diverter plate being movable by the selectable control so as to obstruct one of the first outflow exhaust conduit, or the second outflow exhaust conduit.

3. The ice-melting exhaust diverter of claim 2, wherein the selectable control includes a rotating arm connected to the diverter plate.

4. The ice-melting exhaust diverter of claim 3, wherein the selectable control includes a selector arm connected to the rotating arm.

5. The ice-melting exhaust diverter of claim 4, wherein the selector arm is connected to a control cable that runs from the selectable flow controller to an operational location.

6. The ice-melting exhaust diverter of claim 5, wherein the operational location is inside an automobile trunk.

7. The ice-melting exhaust diverter of claim 1, wherein the inflow exhaust conduit attaches directly to a muffler connected to a combustion engine exhaust system.

8. The ice-melting exhaust diverter of claim 1, wherein an opening of the second outflow exhaust conduit configured to release exhaust downward is substantially parallel to the ground.

9. The ice-melting exhaust tail pipe of claim 1, wherein an opening of the second outflow exhaust conduit configured to release exhaust downward s configured to be at an angle of approximately 45 degrees to the ground.

10. An ice-melting automotive exhaust apparatus comprising:
a remote-located selector; and
a bi-directional exhaust flow diverter having:
an exhaust inflow opening,
an exhaust outflow rearward opening,
an exhaust outflow downward opening, and
an exhaust flow diverter plate configured to direct exhaust flow from the exhaust inflow opening, to either the exhaust outflow rearward opening or the exhaust outflow downward opening;
wherein the remote-located selector is operatively connected to the exhaust flow diverter plate, and positions the exhaust flow diverter plate so as to obstruct one of the exhaust outflow rearward opening and the exhaust outflow downward opening.

11. The apparatus of claim 10, wherein the remote-located selector includes a cable running from an automobile trunk to a selector arm controlling the exhaust flow diverter plate.

12. The apparatus of claim 11, wherein the selector arm is connected to a rotating arm, and the rotating arm is connected to the diverter plate.

13. The apparatus of claim 11, wherein the remote-located selector is a tensioned cable connected to the selector arm.

14. The apparatus of claim 11, wherein the selector arm is connected to the rotating arm at an angle of approximately 90 degrees.

15. The apparatus of claim 10, wherein the exhaust outflow downward opening is configured at an angle of approximately 45 degrees with respect to the exhaust tail pipe.

16. The apparatus of claim 10, wherein the exhaust outflow downward opening is substantially parallel to a road surface.

17. The apparatus of claim 10, wherein the exhaust inflow opening attaches to a muffler on a vehicle having a combustion engine.

18. The apparatus of claim 10, wherein the exhaust outflow downward opening is a lateral flow spreader configured to spread out the flow of hot exhaust gases over a road surface.

19. A method of melting ice under a vehicle, comprising:
operating an internal combustion engine over an icy road surface;
selecting a downward direction for exhaust flow on a bi-directional exhaust diverter connected to the internal combustion engine; and
melting ice on the icy road surface using the exhaust flowing downward from the bidirectional exhaust diverter to the icy road surface.

20. The method of claim 19, wherein selecting a downward direction for exhaust flow includes operating a remotely-located control cable connected to a selector arm so as to obstruct an exhaust outflow rearward opening, thereby directing exhaust flow through an exhaust outflow downward opening.
